(19) United States
(12) Patent Application Publication
(10) Pub. No.: US 2026/0348662 A1
(43) Pub. Date: Nov. 5, 2026

(54) PLASMA METAL MELTING FURNACE WITH ADDITIONAL GASES

(71) Applicant: Novelis Inc., Atlanta, GA (US)

(72) Inventors: Mark Hadley, Greer, SC (US); Steven Dinsmore, Hendersonville, TN (US)

(73) Assignee: Novelis Inc., Atlanta, GA (US)

(21) Appl. No.: 19/106,450

(22) PCT Filed: Aug. 28, 2023
(86) PCT No.: PCT/US2023/072975

§ 371 Date: Feb. 25, 2025

Related U.S. Application Data
(60) Provisional application No. 63/374,119, filed on Aug. 31, 2022.

(51) Int. Cl. F27B 3/20; C22B 7/00; C22B 9/22; C22B 21/00; F27B 3/28; F27D 7/02; F27D 19/00; F27D 99/00

(52) U.S. Cl. CPC F27B 3/20; C22B 7/003; C22B 9/226; C22B 21/0092; F27B 3/28; F27D 7/02; F27D 19/00; F27D 99/0006; F27D 2019/0009; F27D 2019/0031; F27D 2099/0031

(57) ABSTRACT

A melting furnace system for melting metals including but not limited to aluminum and aluminum alloys includes a plasma gas supply and a supplemental gas system. The plasma gas supply supplies a plasma gas to a melting chamber of a melting furnace of the melting furnace system. The supplemental gas system supplies a supplemental gas into the melting chamber and supplies an exhaust control gas to an exhaust gas from the melting chamber. A method of melting a metal with the melting furnace system includes providing the metal in the melting chamber, supplying the plasma gas to the melting chamber for heating the melting chamber, and supplying the supplemental gas to the melting chamber.

### REFERENCE TO RELATED APPLICATION

This application claims the benefit of U.S. Provisional Patent Application No. 63/374,119, filed on Aug. 31, 2022, and entitled PLASMA METAL MELTING FURNACE WITH ADDITIONAL GASES, the content of which is hereby incorporated by reference in its entirety.

### FIELD OF THE INVENTION

This application relates to systems and methods for melting metal material, such as but not limited to aluminum scrap material. More particularly, the application relates to plasma-fired furnaces for melting metal material.

### BACKGROUND

Metal material such as but not limited to scrap material made of aluminum or aluminum alloys may be recycled by melting the metal material using a melting furnace and casting the molten metal for re-use. Conventional melting furnaces typically use natural gas to create combustion gases (e.g., using a burner) that are directed into a melting chamber of the melting furnace. Combustion gases are hot and heat the walls of the melting furnace, the roof of the melting furnace, the melted aluminum, and/or the solid aluminum, and the heating of the solid aluminum forms melted or molten aluminum. Combustion gases are conventionally exhausted from the melting chamber into the atmosphere, and a furnace pressure may be controlled by controlling the rate of exhaustion of the combustion gases. Conventional natural gas-fired melting furnaces may be resource-intensive to provide a desired heat input into the melting chamber.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a melting furnace system includes a plasma gas supply for supplying a plasma gas to a melting chamber of a melting furnace of the melting furnace system. The melting furnace system includes a supplemental gas system for supplying a supplemental gas into the melting chamber and an exhaust control gas to supply an exhaust gas from the melting chamber.

According to some embodiments, a melting furnace system includes a plasma gas supply for supplying a plasma gas to a melting chamber of a melting furnace of the melting furnace system. The melting furnace system may also include a supplemental gas system with a supplemental gas supply for supplying a supplemental gas to the melting chamber. In certain embodiments, the supplemental gas is configured to control a furnace pressure within the melting chamber.

According to various embodiments, a method of melting a metal with a melting furnace system includes providing the metal in a melting chamber of a melting furnace of the melting furnace system, supplying a plasma gas to the melting chamber for heating the melting chamber, and supplying a supplemental gas to the melting chamber.

Various implementations described herein may include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates a melting furnace system according to embodiments.

FIG. 2 illustrates another melting furnace system according to embodiments.

### DETAILED DESCRIPTION

Described herein are plasma-based systems and methods for melting metal material such as but not limited to aluminum and aluminum alloys.

Plasma-based systems traditionally have not been used for melting furnace systems for a variety of reasons. In one aspect, the furnace pressure within a melting chamber of a melting furnace is an important control factor during a melting process. In typical combustion systems, a positive furnace pressure is maintained within the furnace to keep air infiltration out because air infiltration may negatively influence the melting process. As an example, air infiltration during the melting of aluminum or aluminum alloys may result in the formation of aluminum oxide. However, because plasma-based burners operate at a higher temperature compared to conventional combustion burners, the plasma-based burners must be operated at a lower flow rate to achieve an equivalent heat output within the chamber (e.g., suitable for melting metal within the melting furnace). Such a lower flow of plasma-based burners makes it difficult to control the furnace pressure within the melting chamber. In another aspect, specific types of plasma gases have posed other challenges. For example, Nobel and diatomic plasma gases such as plasma argon and plasma nitrogen require significantly high temperatures to have the ability to transfer heat radiatively, and cooling below such temperatures causes the plasma gas to recombine in the form of their original, non-radiating molecule. As another example, plasma carbon dioxide may improve heat transfer for temperatures below those of Nobel and diatomic plasma gases, but plasma carbon dioxide produces excessive amounts of carbon monoxide (CO), which is a poison.

The systems and methods described herein may use a supply of a plasma gas as well as a supply of a supplemental gas. Optionally, the systems and methods described herein may use an exhaust control gas. The plasma gas may provide heating for a melting chamber of a melting furnace, which may provide improved heating due to radiative properties of the plasma gas compared to traditional techniques. In some optional embodiments, the plasma gas may be a mixture of gases including but not limited to plasma carbon dioxide. In certain embodiments, the supplemental gas may provide control of furnace pressure within the melting chamber, which may allow the melting furnace system to reduce and/or prevent the unwanted infiltration of air into the melting chamber. In various embodiments, the exhaust control gas may include exhaust gas from the melting chamber. Optionally, the exhaust control gas may be atmospheric air and/or other suitable gases for controlling the exhaust gas. In certain embodiments, the exhaust control gas may introduce oxygen into the exhaust gas from the melting chamber, which may allow carbon monoxide to burn out to carbon dioxide if the plasma gas is plasma carbon dioxide. Various other benefits and advantages may be realized with the systems and methods provided herein, and the aforementioned advantages should not be considered limiting.

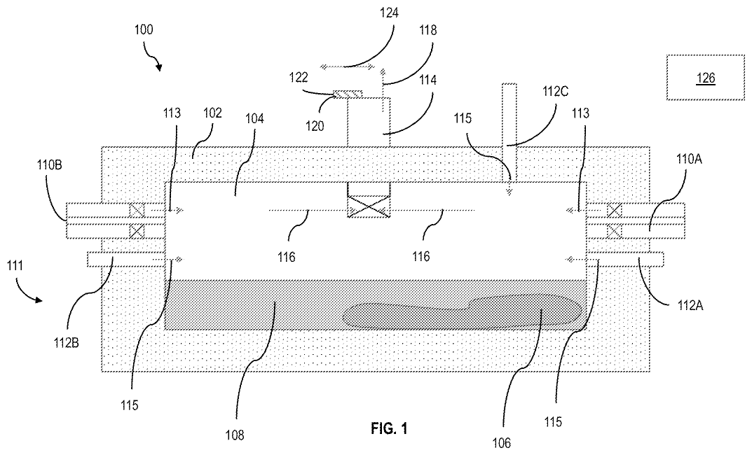

FIG. 1 illustrates a melting furnace system 100 according to embodiments. As illustrated in FIG. 1, the melting furnace system 100 includes a melting furnace 102 with a melting chamber 104. During a melting process and as discussed in detail below, a solid metal material 106 may be melted into molten metal 108, which may be subsequently used as desired. The particular melting furnace 102 and melting chamber 104 illustrated should not be considered limiting.

The melting furnace system 100 includes one or more plasma burners 110 that generate and supply a plasma gas into the melting chamber 104 such that radiative heating from the plasma gas heats the melting chamber 104 and any contents therein. In the embodiment illustrated, the melting furnace system 100 includes two plasma burners 110A-B, and the flow of the plasma gas from each plasma burner 110A-B is represented by arrows 113. The particular location of the plasma burners 110A-B illustrated in FIG. 1 should not be considered limiting. Moreover, in other embodiments, any number of plasma burners may be utilized as desired.

The plasma gas supplied by the plasma burners 110 may be various types of plasma gas as desired and/or suitable for melting the metal material 106. As non-limiting examples, the plasma gas may be plasma nitrogen, plasma argon, and/or plasma carbon dioxide. In one non-limiting example, to provide improved radiative heating at lower temperatures, the plasma gas may be plasma carbon dioxide. In certain embodiments, a plurality of plasma gases may be used to heat the melting chamber 104. In such embodiments, each plasma gas may be supplied separately. As a non-limiting example, the plasma burner 110A may supply plasma carbon dioxide and the plasma burner 110B may supply plasma nitrogen. Various other combinations of plasma gases may be used in other melting furnace systems as desired.

In addition to the one or more plasma burners 110 supplying the plasma gases, the melting furnace system 100 includes a supplemental gas system 111 that includes one or more supplemental gas supplies 112 for supplying a supplemental gas into the melting chamber 104. In the embodiment illustrated in FIG. 1, the melting furnace system 100 includes three supplemental gas supplies 112A-C, and a flow of supplemental gas from each supplemental gas supply 112A-C is represented by arrows 115. In other embodiments, the melting furnace system 100 may include any number of supplemental gas supplies as desired. In addition, the particular location of the supplemental gas supplies 112A-C should not be considered limiting.

The supplemental gas supplied by each supplemental gas supply 112A-C may be used to control the furnace pressure within the melting chamber 104 as discussed in detail below. Various gases and/or mixtures of gases may be used as the supplemental gas as desired. As non-limiting examples, the supplemental gases may be carbon dioxide, recycled exhaust gas (e.g., gas vented from the melting chamber 104), and/or various other suitable supplemental gases and/or mixtures of supplemental gases as desired.

One or more exhaust flues 114 or other suitable conduit may be provided to vent an exhaust gas from the melting chamber 104. Flow into the flue 114 is represented by arrows 116, and flow of the exhaust gas out of the flue 114 is represented by arrow 118. In various embodiments, the melting furnace system 100 includes a pressure control device 120. The pressure control device 120 may at least partial control the flow rate of the exhaust gas out of the exhaust flue 114, thereby at least partially controlling the furnace pressure within the melting chamber 104. In the embodiment illustrated in FIG. 1, the pressure control device 120 is a slidable door 122, and movement of the slidable door 122 is represented by arrow 124. However, in other embodiments, the pressure control device 120 may be various other suitable devices or mechanisms for controlling the flow rate of the exhaust gas from the exhaust flue 114.

Optionally, the melting furnace system 100 includes a controller 126, which may include one or more processing units and/or one or more memory devices. The processing unit of the controller may be various suitable processing devices or combinations of devices including but not limited to one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units, and/or a combination thereof. The one or more memory devices of the controller 126 may be any machine-readable medium that can be accessed by the processor, including but not limited to any type of long term, short term, volatile, nonvolatile, or other storage medium, and is not to be limited to any particular type of memory or number of memories, or type of media upon which memory is stored. Moreover, as disclosed herein, the term “storage medium”, “storage” or “memory” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels, and/or various other storage mediums capable of storing that contain or carry instruction(s) and/or data.

In certain embodiments, the controller 126 optionally includes an associated user interface, including but not limited to a graphical user interface, such that the controller 126 may obtain information from a user and/or provide information to the user. In such embodiments, the user interface may be on the controller 126 itself or may be at a location remote from the controller 126 such as, but not limited to, another location within the melting furnace system 100. Additionally or alternatively, the controller 126 optionally may include various communication modules such that the controller 126 may receive and/or send information as desired. Non-limiting examples of communication modules may include systems and mechanisms enabling wired communication and/or wireless communication (e.g., Industrial Ethernet, Profibus®, near field, cellular, Wi-Fi, Bluetooth®, Bluetooth Low Energy (BLE), etc.).

The controller 126 may be communicatively coupled to one or more components of the melting furnace system 100 such as, but not limited to, one or more of the plasma burners 110, a gas supply for one or more of the plasma burners 110, a flow controller for one or more of the supplemental gas supplies 112, and/or the pressure control device 120. Optionally, one or more sensors may be provided within the melting chamber 104 and/or as otherwise desired for providing information about the furnace pressure and/or the exhaust gas, and the controller 126 may control one or more components of the melting furnace system 100 based on such information.

As mentioned, the flow rate of the plasma gas into the melting chamber 104 may be relatively low. In such cases, the flow rate of the supplemental gases may be controlled (e.g., by the controller 126, by an operator, and/or as otherwise desired) to control the furnace pressure within the melting chamber 104. In certain embodiments, the flow rate of the supplemental gas may be controlled to maintain a positive furnace pressure within the melting chamber 104, which may reduce and/or prevent the unwanted infiltration of air into the melting chamber (e.g., by infiltrating through the exhaust flue 114). As non-limiting examples, the flow rate of the supplemental gas into the melting chamber 104 may be increased if the furnace pressure is below a threshold value and/or decreasing, and the flow rate of the supplemental gas into the melting chamber 104 may be maintained and/or decreased if the furnace pressure is at or above the threshold value. In embodiments with a plurality of supplemental gas supplies 112, the supplemental gas supplies 112 may be jointly controlled or each supplemental gas supply 112 may be independently controlled. In some embodiments, the furnace pressure optionally is additionally controlled by controlling the pressure control device 120. As a non-limiting example, the pressure control device 120 may be controlled to increase the furnace pressure by restricting the flow of the exhaust gas from the exhaust flue 114. Various other controls of the supplemental gas and/or the pressure control device 120 may be implemented as desired for controlling the furnace pressure. As such, the melting furnace system 100 both may beneficially use plasma gas for radiative heating while providing a desired furnace pressure within the melting chamber 104.

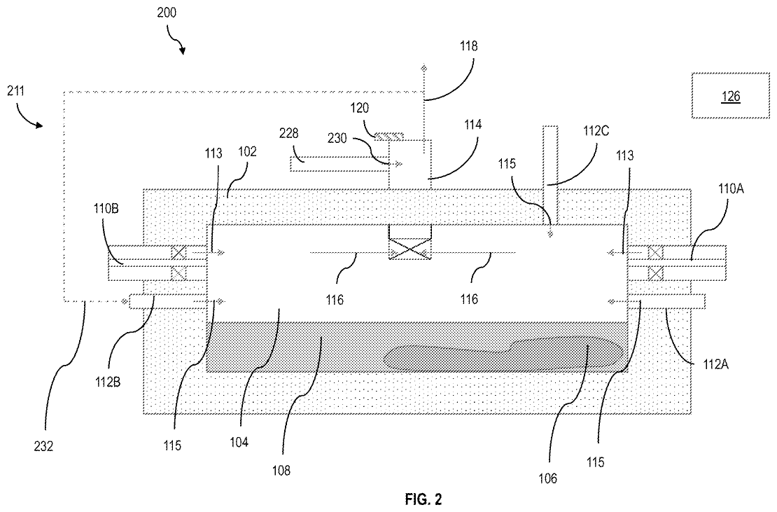

FIG. 2 illustrates another melting furnace system 200 according to embodiments. The melting furnace system 200 is substantially similar to the melting furnace system 100 and includes a supplemental gas system 211. The supplemental gas system 211 is substantially similar to the supplemental gas system 111 except that the supplemental gas system 211 additionally includes an exhaust control gas supply 228. The exhaust control gas supply 228 supplies an exhaust control gas into the exhaust gas that is exhausted from the melting chamber 104 (i.e., the combined plasma gas and supplemental gas). Flow of the exhaust control gas is represented by arrows 230 in FIG. 2. The exhaust control gas may be various gases suitable for controlling the exhaust gas. In certain embodiments, the exhaust control gas may include free oxygen and/or be a gas with a molecular structure having free oxygen. In one non-limiting example, the exhaust control gas may be atmospheric air. In other embodiments, the exhaust control gas may be the same as the supplemental gas. The exhaust control gas introduced into the exhaust gas may allow carbon monoxide to burn out to carbon dioxide if the plasma gas is plasma carbon dioxide. Stated differently, the exhaust control gas may be used to control the exhaust gas to minimize or reduce the emission of carbon monoxide and/or other harmful gases. In certain embodiments, the exhaust control gas optionally may be controlled to control the furnace pressure. As non-limiting examples, the exhaust control gas may be provided at various rates, which in turn may control the rate at which the combined gases are exhausted from the melting chamber 104 and thus, may control the furnace pressure.

As illustrated in FIG. 2, the supplemental gas system 211 includes a return supply 232 that returns at least some of the exhaust gas exiting the exhaust flue 114 back to one or more of the supplemental gas supplies 112 for use as the supplemental gas. In the embodiment of FIG. 2, the return supply (represented by dashed line 232) includes the exhaust gas mixed with the exhaust control gas, although it need not in other embodiments. As a non-limiting example, the return supply 232 may be provided with the melting furnace system 100 for returning the exhaust gas (e.g., without the exhaust control gas) to one or more of the supplemental gas supplies 112.

Referring back to FIG. 1, a method of melting the solid metal material 106 with a melting furnace system 100 to form the molten metal 108 includes providing the solid metal material 106 in the melting chamber 104. The method includes supplying the plasma gas to the melting chamber 104 using a plasma supply such as the one or more plasma burners 110 for heating the melting chamber. The method includes supplying the supplemental gas to the melting chamber 104 using the one or more supplemental gas supplies 112. In various embodiments, the method includes controlling the furnace pressure by controlling the supplemental gas provided by the one or more supplemental gas supplies 112. Various other processes may be performed, and the aforementioned control process should not be considered limiting.

A collection of exemplary embodiments are provided below, including at least some explicitly enumerated as “Illustrations” providing additional description of a variety of example embodiments in accordance with the concepts described herein. These illustrations are not meant to be mutually exclusive, exhaustive, or restrictive; and the disclosure not limited to these example illustrations but rather encompasses all possible modifications and variations within the scope of the issued claims and their equivalents.

Illustration 1. A melting furnace system comprising: a plasma gas supply for supplying a plasma gas to a melting chamber of a melting furnace of the melting furnace system; and a supplemental gas system configured to supply a supplemental gas into the melting chamber and configured to supply an exhaust control gas to an exhaust gas from the melting chamber.

Illustration 2. The melting furnace system of any preceding or subsequent illustrations or combination of illustrations, further comprising the melting furnace defining the melting chamber, wherein the melting furnace further comprises an exhaust flue for exhausting the combined plasma gas and supplemental gas from the melting chamber as the exhaust gas.

Illustration 3. The melting furnace system of any preceding or subsequent illustrations or combination of illustrations, further comprising a pressure control device configured to control an exhaust rate of the combined plasma gas and supplemental gas from the melting chamber.

Illustration 4. The melting furnace system of any preceding or subsequent illustrations or combination of illustrations, further comprising a controller configured to control the pressure control device based on a detected furnace pressure within the melting chamber.

Illustration 5. The melting furnace system of any preceding or subsequent illustrations or combination of illustrations, further comprising a controller configured to control at least one of the plasma gas supply or the supplemental gas supply.

Illustration 6. The melting furnace system of any preceding or subsequent illustrations or combination of illustrations, wherein the plasma gas comprises at least one of plasma argon, plasma nitrogen, or plasma carbon dioxide.

Illustration 7. The melting furnace system of any preceding or subsequent illustrations or combination of illustrations, wherein the supplemental gas comprises an exhaust gas from the melting chamber.

Illustration 8. The melting furnace system of any preceding or subsequent illustrations or combination of illustrations, wherein the supplemental gas comprises carbon dioxide.

Illustration 9. A melting furnace system comprising: a plasma gas supply for supplying a plasma gas to a melting chamber of a melting furnace of the melting furnace system; and a supplemental gas system comprising a supplemental gas supply for supplying a supplemental gas to the melting chamber, wherein the supplemental gas is configured to control a furnace pressure within the melting chamber.

Illustration 10. The melting furnace system of any preceding or subsequent illustrations or combination of illustrations, further comprising: the melting furnace defining the melting chamber; and an exhaust for exhausting the combined plasma gas and supplemental gas from the melting chamber.

Illustration 11. The melting furnace system of any preceding or subsequent illustrations or combination of illustrations, further comprising a pressure control device configured to control an exhaust rate of the combined plasma gas and supplemental gas from the melting chamber.

Illustration 12. The melting furnace system of any preceding or subsequent illustrations or combination of illustrations, wherein at least a portion of the combined plasma gas and supplemental gas is provided as the supplemental gas.

Illustration 13. The melting furnace system of any preceding or subsequent illustrations or combination of illustrations, wherein the plasma gas comprises at least one of plasma argon, plasma nitrogen, or plasma carbon dioxide.

Illustration 14. The melting furnace system of any preceding or subsequent illustrations or combination of illustrations, wherein the plasma gas comprises plasma carbon dioxide.

Illustration 15. The melting furnace system of any preceding or subsequent illustrations or combination of illustrations, wherein the supplemental system if further configured to supply an exhaust control gas into an exhaust gas from the melting chamber Illustration 16. A method of melting a metal with a melting furnace system, the method comprising: providing the metal in a melting chamber of a melting furnace of the melting furnace system; supplying a plasma gas to the melting chamber for heating the melting chamber; and supplying a supplemental gas to the melting chamber.

Illustration 17. The method of any preceding or subsequent illustrations or combination of illustrations, wherein supplying the plasma gas comprises supplying at least one of plasma argon, plasma nitrogen, or plasma carbon dioxide.

Illustration 18. The method of any preceding or subsequent illustrations or combination of illustrations, further comprising supplying an exhaust control gas to an exhaust gas vented from the melting chamber.

Illustration 19. The method of any preceding or subsequent illustrations or combination of illustrations, wherein the exhaust control gas comprises atmospheric air.

Illustration 20. The method of any preceding or subsequent illustrations or combination of illustrations, wherein the supplemental gas comprises carbon dioxide.

Illustration 21. The method of any preceding or subsequent illustrations or combination of illustrations, further comprising controlling the supplying of the mixture of the supplemental gas and the atmospheric air with a controller and based on a furnace pressure within the melting chamber.

The subject matter of embodiments is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others, are intended to refer to the orientation as illustrated and described in the figure (or figures) to which the components and directions are referencing. In the figures and the description, like numerals are intended to represent like elements. Throughout this disclosure, a reference numeral with a letter refers to a specific instance of an element and the reference numeral without an accompanying letter refers to the element generically or collectively. Thus, as an example (not shown in the drawings), device “12A” refers to an instance of a device class, which may be referred to collectively as devices “12” and any one of which may be referred to generically as a device “12”. As used herein, the meaning of “a,” “an,” and “the” includes singular and plural references unless the context clearly dictates otherwise.

The above-described aspects are merely possible examples of implementations, merely set forth for a clear understanding of the principles of the present disclosure. Many variations and modifications may be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

That which is claimed:

1. A melting furnace system comprising:
a plasma gas supply for supplying a plasma gas to a melting chamber of a melting furnace of the melting furnace system; and
a supplemental gas system configured to supply a supplemental gas into the melting chamber to mix with the plasma gas to form a combined gas and configured to supply an exhaust control gas to an exhaust gas from the melting chamber.

2. The melting furnace system of claim 1, further comprising the melting furnace defining the melting chamber, wherein the melting furnace further comprises an exhaust flue for exhausting the combined gas from the melting chamber as the exhaust gas.

3. The melting furnace system of claim 2, further comprising a pressure control device configured to control an exhaust rate of the combined gas from the melting chamber.

4. The melting furnace system of claim 3, further comprising a controller configured to control the pressure control device based on a detected furnace pressure within the melting chamber.

5. The melting furnace system of claim 1, further comprising a controller configured to control at least one of the plasma gas supply or the supplemental gas supply.

6. The melting furnace system of claim 1, wherein the plasma gas comprises at least one of plasma argon, plasma nitrogen, or plasma carbon dioxide.

7. The melting furnace system of claim 1, wherein the supplemental gas comprises an exhaust gas from the melting chamber.

8. The melting furnace system of claim 1, wherein the supplemental gas comprises carbon dioxide.

9. A melting furnace system comprising:
a plasma gas supply for supplying a plasma gas to a melting chamber of a melting furnace of the melting furnace system; and
a supplemental gas system comprising a supplemental gas supply for supplying a supplemental gas to the melting chamber, wherein the supplemental gas is configured to control a furnace pressure within the melting chamber.

10. The melting furnace system of claim 9, further comprising:
the melting furnace defining the melting chamber; and
an exhaust for exhausting the combined plasma gas and supplemental gas from the melting chamber.

11. The melting furnace system of claim 10, further comprising a pressure control device configured to control an exhaust rate of the combined plasma gas and supplemental gas from the melting chamber.

12. The melting furnace system of claim 10, wherein at least a portion of the combined plasma gas and supplemental gas is provided as the supplemental gas.

13. The melting furnace system of claim 9, wherein the plasma gas comprises at least one of plasma argon, plasma nitrogen, or plasma carbon dioxide.

14. The melting furnace system of claim 13, wherein the plasma gas comprises plasma carbon dioxide.

15. The melting furnace system of claim 9, wherein the supplemental system is further configured to supply an exhaust control gas into an exhaust gas from the melting chamber.

16. A method of melting a metal with a melting furnace system, the method comprising:
providing the metal in a melting chamber of a melting furnace of the melting furnace system;
supplying a plasma gas to the melting chamber for heating the melting chamber; and
supplying a supplemental gas to the melting chamber.

17. The method of claim 16, wherein supplying the plasma gas comprises supplying at least one of plasma argon, plasma nitrogen, or plasma carbon dioxide.

18. The method of claim 16, further comprising supplying an exhaust control gas to an exhaust gas vented from the melting chamber.

19. The method of claim 18, wherein the exhaust control gas comprises atmospheric air.

20. The method of claim 16, wherein the supplemental gas comprises carbon dioxide.
